(19) United States
(12) Patent Application Publication
(10) Pub. No.: US 2002/0092237 A1
(43) Pub. Date: Jul. 18, 2002

(54) Device for controlling a door operator

(76) Inventor: Thomas J. Hebda, Lombard, IL (US)

Correspondence Address: Robert L. Marsh, P.O. Box 4468, Wheaton, IL, 60189-4468, US

(21) Appl. No.: 09/925,588

(22) Filed: Aug. 9, 2001

Related U.S. Application Data
(63) Continuation-in-part of application No. 09/362,248, filed on Jul. 28, 1999, now Pat. No. 6,347,485.

(51) Int. Cl. E05F 11/02; E05F 11/24

(52) U.S. Cl. 49/339; 49/340; 49/279

(57) ABSTRACT

To open a door which is latched in the closed position, a rotatable door handle must be turned to unlatch the door, after which the door can be opened. A door unlatching device is provided to rotate the handle, and a door operator moves the door from the closed position to the open position. An assist will provide additional force to move the door out of the door frame to the ajar position. A microprocessor receives input from all three devices and provides for the unification of the movements of the components to unlatch and open the door.

This is a continuation in part of my copending application filed Jul. 28, 1999 and assigned Ser. No. 09/362,248. The present invention relates to motor driven mechanisms for opening and closing a door having a door latch and a second device for operating the door latch and, in particular, to a control for synchronizing the operation of the door operator and the door latch operator.

### BACKGROUND OF THE INVENTION

Many devices are available which use electric motors to control the opening and closing of a door to a room by initiating a signal from a remote location, such as a wheelchair or a desk. The device may apply force for both the opening and the closing of the door or the door may be fitted with a spring loaded door closer such that power is needed only to open the door.

There are also many alternatives regarding how such control devices function. For example, the device may open a door on command and hold the door open for a short period of time, after which the device will return the door to the closed position. Alternately, the door may remain open until another start signal initiates a door closing sequence. If an obstruction is encountered during an opening or a closing sequence a slip clutch may prevent damage to the system. As an alternative, an obstruction sensing detector circuit may signal the shut down of power or the reversing of power to the motor.

Handicapped people confined to a wheelchair, using a walker or having other limitations would like to have a door operating device to control the operation of every door where privacy is needed in their daily routine, such as an entry way door, a bedroom door, and a bathroom door.

Generally, the operation of the door requires more than merely swinging the door on its hinges between its open and closed positions. The door must be unlatched from a door before it is opened and be relatched after the door is closed. Where latching and unlatching is needed it is common to use an electric latch release which electrically releases a latch plate built into a door jam whereby the latch bolt is released from the latch plate without requiring the latch bolt to be withdrawn by the turning of a door knob or the like. The installation of latch releases, however, is expensive because of the carpentry work needed to alter the door jam, and the electrical modifications needed to meet the power demands of such latch releases. Such latch releases are also unpleasantly noisy to operate. The difficulties to the handicapped may become exacerbated if the door controlling system is used of a door having weather stripping or the like which causes such resistance to the movement of the door into or out of a door jam that the door operating device cannot operate properly.

It would, therefore, be desirable to provide an improved control which would allow a handicapped person to open a latched door and to close and relatch an open door without bearing the expense which is presently required to install the necessary equipment.

In my copending application, Ser. No. 09/397,268 filed Sep. 16, 1999, I disclosed a device for operating a door latch which is attachable to a door for rotating the handle of a door to withdraw a latch bolt, thereby unlatching the door so it may be opened. In my co pending application, Ser. No. 09/362,248 filed Jul. 28, 1999, I disclosed a power assist for providing additional force for moving a door between an ajar position and a closed position. Although the unlatching device and the power assist are both independently useable, it would be desirable to provide for a unified system employing the inventions all of my pending applications to unlatch and open a door.

### SUMMARY OF THE INVENTION

Briefly, the present invention is a door controlling device for opening and closing a door in a wall. The invention includes a door operating device having a motor driven linkage with one end of the linkage attached to a wall and the other end of the linkage attached to a door. Rotation of the motor in a first direction causes movement of the linkage to force the door from a closed position to an open position and rotation of the motor in the opposite direction causes movement of the door from an open position to a closed position. A signal to initiate an opening or closing cycle is received from a hard wired button or a hand held unit. The door controlling device also has detectors or stops for stopping movement of the door after it reaches the open position and the closed position.

The invention further includes an assist for applying additional force to the door, the assist having a second motor for movement of the door between an ajar position and a closed position. The motor for the assist is initiated and terminated in response to signals from detectors which operate independent of the door controller for sensing the movement of the door between the open, the ajar and the closed positions.

An unlatching device for unlatching the door at the onset of the door opening cycle has a third motor and related detectors needed to carry out its operations.

A unified control receives inputs from the detectors of all three devices and it controls the operation of the motors for the door operating device, the assist, and the door unlatching device. When the door is closed and latched, and a start signal is sent, the unified control device directs power to the motor for the unlatching device to unlatch the door, after which the motor to the power assist is operated to push the door from the closed position to an ajar position. Finally, power is directed to the motor for the door operating device to open the door. When the door is open and the unified control receives a signal calling the device into action, power is directed to the motor for the operating device to move the door from an open position to the closed position. The door latching device may be simultaneously operated to unlatch the door and thereby reduce the resistance to closing the door. When the door reaches the ajar position, power is directed to the motor for the assist to apply additional force to move the door from the ajar position to the closed position. Finally, after the door is fully closed, the motor for the unlatching device relatches the door.

### BRIEF DESCRIPTION OF THE DRAWINGS

A better and more complete understanding of the invention will be had after a reading of the following detailed description taken in conjunction with the drawings wherein:

FIG. 1 is a front elevational view of a fragment of a wall having a door therein fitted with a device in accordance with the present invention;

FIG. 2 is an enlarged top elevational view of the door operating device shown in FIG. 1 with the door in the closed position;

FIG. 3 is an enlarged top elevational view of the door operating device shown in FIG. 2 with the door in the open position;

FIG. 4 is a fragmentary further enlarged top elevational view of the door operating device shown in FIGS. 2 and 3;

FIG. 5 is an fragmentary enlarger side elevational view of the door operating device as shown in Fig, 2;

FIG. 6 is a further enlarged fragmentary cross sectional view of the device as shown in FIG. 4 taken through lines 6 - 6 thereof;

FIG. 7 is an enlarged side elevational view of the assist shown in FIG. 1 for assisting in the moving of the door between an ajar position and a closed position, the assist fitted on a door which is spaced in the wall;

FIG. 8 is a side elevational view of the assist shown in FIG. 7 with the door in the ajar position;

FIG. 9 is a top elevational view of the wall, door, and assist shown in FIG. 7 with door again in the ajar position;

FIG. 10 is a side elevational view of the assist shown in FIG. 7 with the door in the closed position;

FIG. 11 is an enlarged front elevational view of the door unlatching device shown in FIG. 1;

FIG. 12 is a further enlarged front elevational view of the door unlatching device shown in FIG. 11 with the cover removed to show the spool and switches therein; and

FIG. 13 is a schematic view of the control device for controlling the door operating devices shown in FIG. 1.

### Detailed Description of the Preferred Embodiment

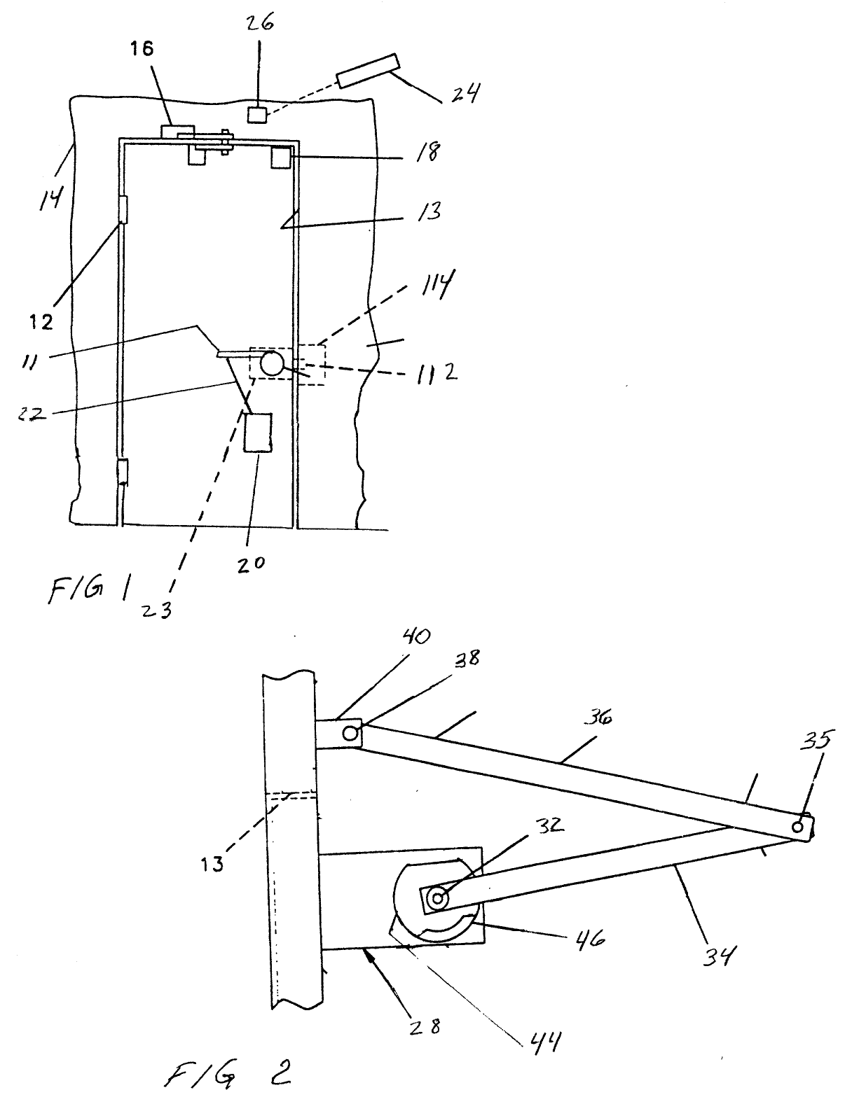

Referring to FIG. 1, a door 10 has a door handle 11 which is pivotally mounted about a horizontal axis on a plurality of pins, one of which 12 is shown, such that the door 10 opens and closed against a frame defining an opening 13 is a wall 14. In accordance with the invention, a door operating device 16 is positioned along the upper edge of the door 10 for moving the door between an open position and a closed position as further described below. An assist 18 which is also attached to the upper end of a door applies additional force for movement of the door between a closed position and an ajar position to overcome the resistance caused by seals and the like between the opening 13 and the outer edge of the door 10. There is also provided an unlatching device 20 mounted on the door 10 having a cable 22, the distal end of which is attached to the distal end of the door handle 11 for turning the door handle 11 and unlatching the door latch 23 as further described below. To begin a door opening cycle, or a door closing cycle, a user depresses a start button which may be hard wired onto a desk or may be an infrared transmitter 24 having an associated receiver 26.

Referring to FIGS. 2 to 5, many types of motor operated door operating devices 16 are available and the invention may be practiced in full or in part by employing any of a number of currently existing door operating devices. In the preferred embodiment, however, the door operating device is of the type disclosed in my copending application, Ser. No. 09/318,066 filed May 24, 1999. For the purposes of this discussion, the door operating device 16 is depicted and described substantially as set forth in my above mentioned application.

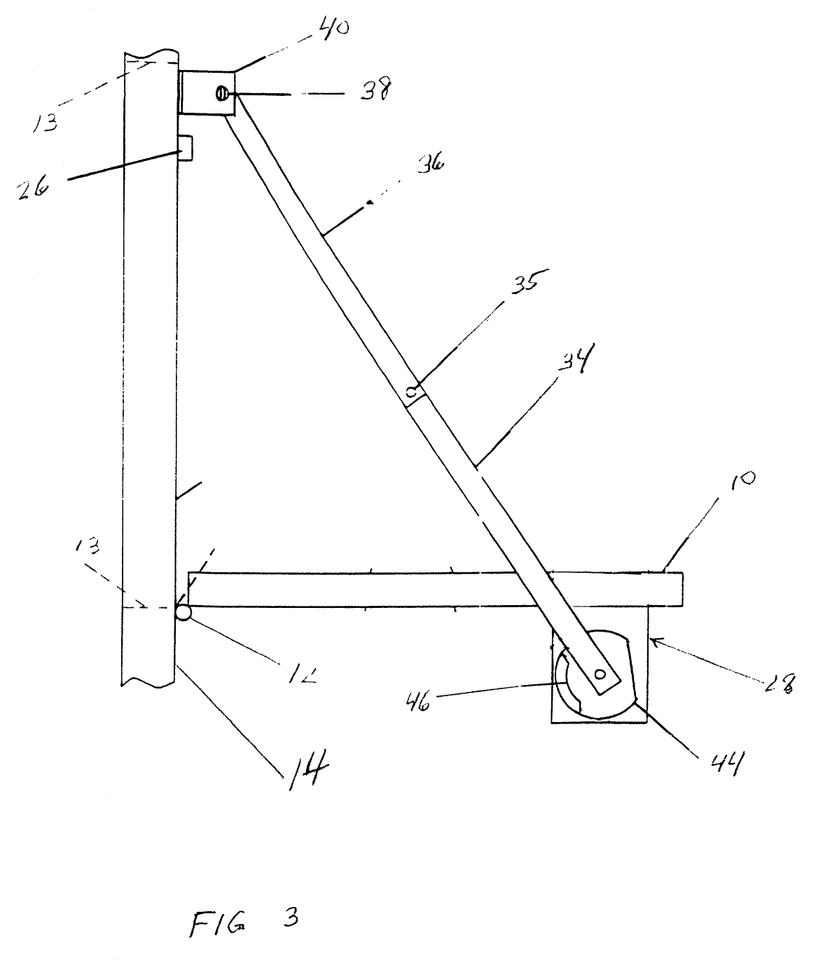

The device 16 has a first bracket 28 for mounting to the door 10. The bracket 28 retains a drive assembly including a motor 30 and a gear box 31 which is drivingly connected to a vertically extending drive shaft 32. Pivotally mounted on the distal end of the drive shaft 32 is one end of a first arm 34. The second end of the first arm 34 is attached by a pin 35 to a second arm 36 and the opposite end of the second arm 36 is mounted by a pin 38 to a second bracket 40 attached to the wall 14. Rotation of the first arm 34 in one direction (counterclockwise as depicted in FIG. 2 and 3) around the drive shaft 32 will move the door 10 from the closed position shown in FIG. 2 to an open position shown in FIG. 3, and rotation of first the arm 34 in opposite (clockwise) direction around the drive shaft 32 will move the door from the open position shown in FIG. 3 to the closed position shown in FIG. 2.

Fixed for rotation with the drive shaft 32 is a generally circular drive cam 44 having a flat 41 and a radially offset axially extending drive pin 46 thereon which extends axially adjacent the mounting of the first arm 34 to the drive shaft 32. As a result, the motorized rotation of the shaft 32, the drive cam 44 and drive pin 46 in one direction will cause the drive pin 46 to abut against one side of the arm 34 and push it through an arc for opening the door 10. Conversely, rotation of the shaft 32, drive cam 44 and drive pin 46 in the opposite direction will cause the pin 46 to abut against the opposite side of the arm 34 and rotate it in the opposite direction for closing the door 10.

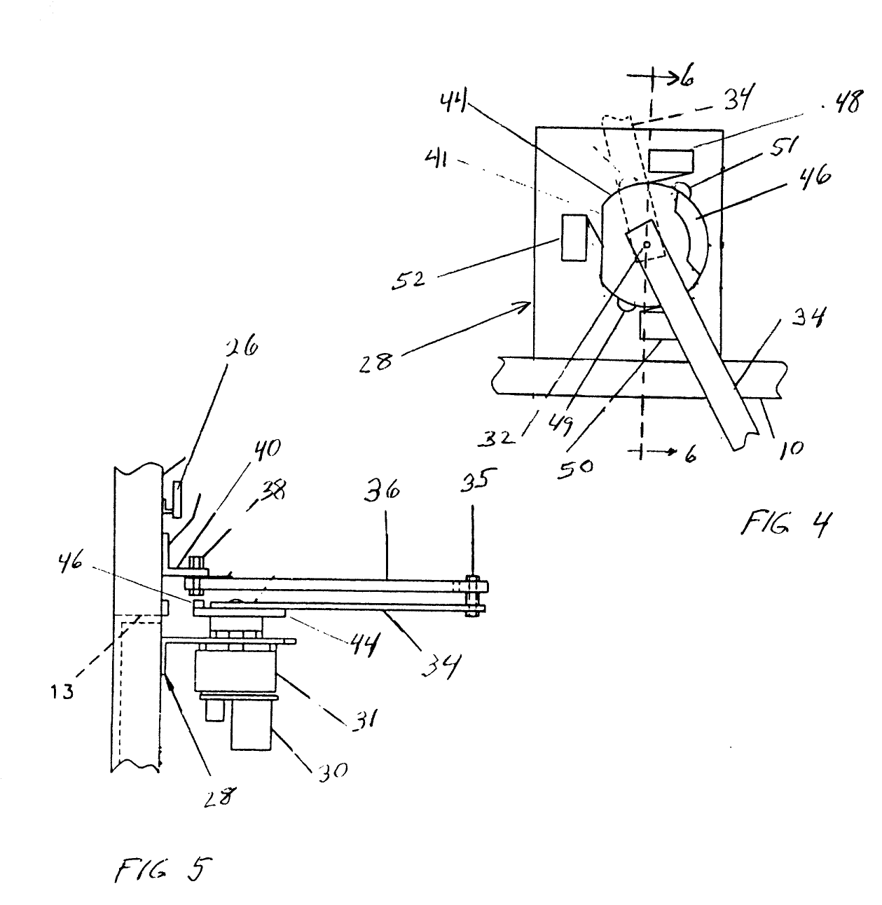

When the door operating device 16 is not in operation, the drive pin 46 is in the orientation depicted in FIG. 4. When in this orientation, the door 10 may be moved from the closed position to the open position, or from the open position to the closed position, causing the arm 34 to rotate about the shaft 32 without contacting the drive pin 46. Accordingly, the door operating device is then in a standby position where it will not interfere with the manual operation of the door.

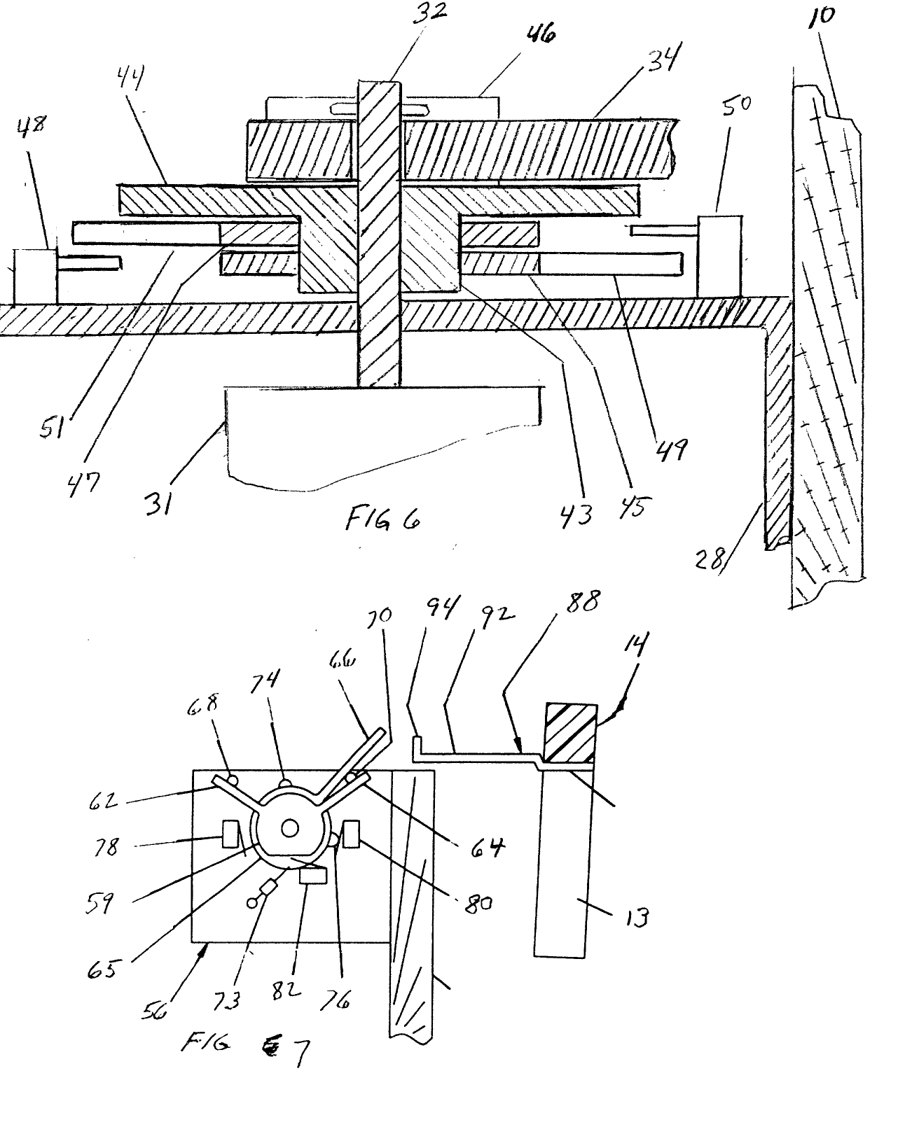

Referring to FIGS. 2 to 6, to open the door 10, the motor 30 drives the pin 46 through a predetermined arc in the first direction (counter-clockwise as depicted in FIGS. 2 and 3) and to close the door and the motor 30 drives the pin 46 moves through a predetermined arc in the second direction (clockwise as depicted in FIGS. 2 and 3). To control the movement of the parts, a first detector switch 52 is positioned to engage the circumference of the cam 44 and to be actuated when the arm thereof encounters the flat 41 indicating that the cam 44 is in the stand by position, as depicted in FIG. 4. As best shown in FIG. 4 and 6, cam 44 has a cylindrical lower portion 43 around which are adjustably fitted two secondary cams 45, 47 having projections 49, 51 respectively, such that cams 45 and 47 rotate with cam 44. A second detector switch 48 is positioned adjacent cam 45 and is actuated by projection 49 when the door 10 is moved to the open position, and a third detector switch 50 is positioned adjacent cam 47 and is actuated by projection 51 of cam 47 when the door 10 is in the closed position. The secondary cams 45, 47 are moveably mounted around the cylindrical portion 43 of cam 44 thereby permitting the adjustment of the positions of the open detector switch 48 and the closed detector switch 50 to the swing characteristics of the door 10. Detector switch 48 is, therefor, positioned with respect to cam 44 to emit a signal when the pin 46 has pushed the arm 34 until the door 10 is in the open position. Detector switch 50 is likewise positioned with respect to cam 44 to emit a signal when the pin 46 has pushed the arm 34 until the door 10 has moved to the closed position. Detector switch 52 is positioned to emit a signal when the pin 46 has returned to the standby position.

Referring briefly to FIG. 13, the circuit for the operating device 16 includes a simple battery 53 so as not to require the attachment into the electrical system of the structure. A current sensor 54 in the power line to the motor 30 detect when the motor 30 is drawing an excess amount of current, thereby indicating that the door has encountered an obstruction. The circuit includes a microprocessor, as further described below, which is programmed to reverse the direction of the motor in the event the opening or closing door encounters an obstruction.

Referring to FIGS. 7 to 10, the door operating device 16 provides sufficient force to move an unobstructed door between the open and closed positions, but the resistance caused by an insulated stripping around the door frame inhibits movement as the door moves between the ajar position and the closed position. To provide additional force for moving the door 10 between the ajar and the closed position, the assist 18 is provided.

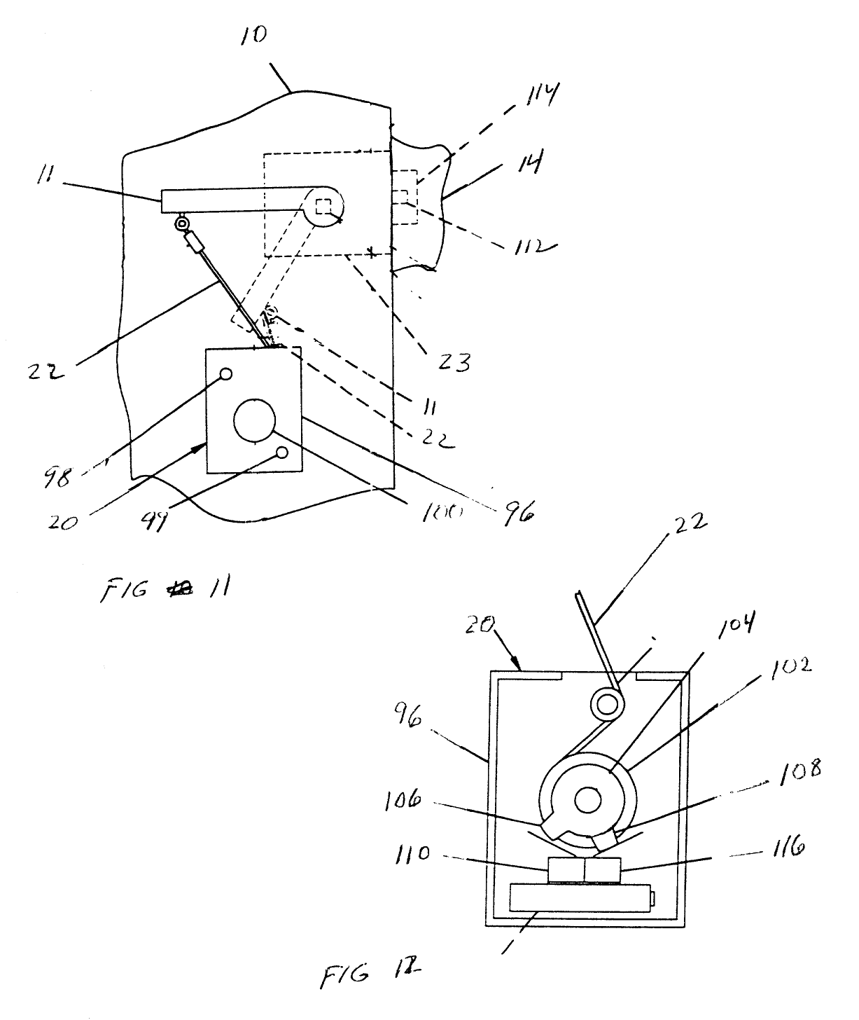

The assist 18 has an engagement unit 56 attachable to the door 10 or the wall 14. The engagement unit 56 includes a motor 58 which drives a shaft 60. Mounted for rotation with the drive shaft 60 is a generally circular cam 59 having a flat 61, and extending radially outward of the shaft 60 and the cam 59 are a pair of drive pins 62, 64. Pivotally mounted about the drive shaft 60 is a rotatable second cam 65 on which is mounted a radially extending detector arm 66 having a length longer than that of the pins 62, 64. A pair of stops 68, 70 limit the movement of the detector arm 66 such that the distal end thereof always extends a distance above the upper edge 72 of the door 10. A spring 73 urges the cam 65 to rotate clockwise as shown in FIGS. 7, 8 and 10, thereby urging detector arm 66 to move towards stop 70. Mounted for movement with the cam 65 are radially extending protrusions 74, 76. Switches 78 and 80 are positioned on the engagement unit 56 at positions adjacent to the cam 65 such that protrusion 76 will actuate the switch arm of switch 78 when the detector arm 66 is near stop 68 and the door is in the closed position as shown in FIG. 10 and protrusion 76 will actuate the switch arm for switch 80 when the detector arm 66 is near the stop 70 and the door is in the open position as shown in FIG. 7. Preferably the protrusions 74, 76 are moveably about a cylindrical portion, not show, of cam 65 so that the sensor switches 78, 80 can be adjusted to be actuated when the door 10 is in the appropriate position.

When the assist 18 is not in use, the pins 62, 64 are oriented such that the distal ends thereof do not extend about the upper surface 72 of the door as shown in FIG. 7. When in this orientation, the flat 61 of cam 59 is engaged by the switch arm of a third switch 82.

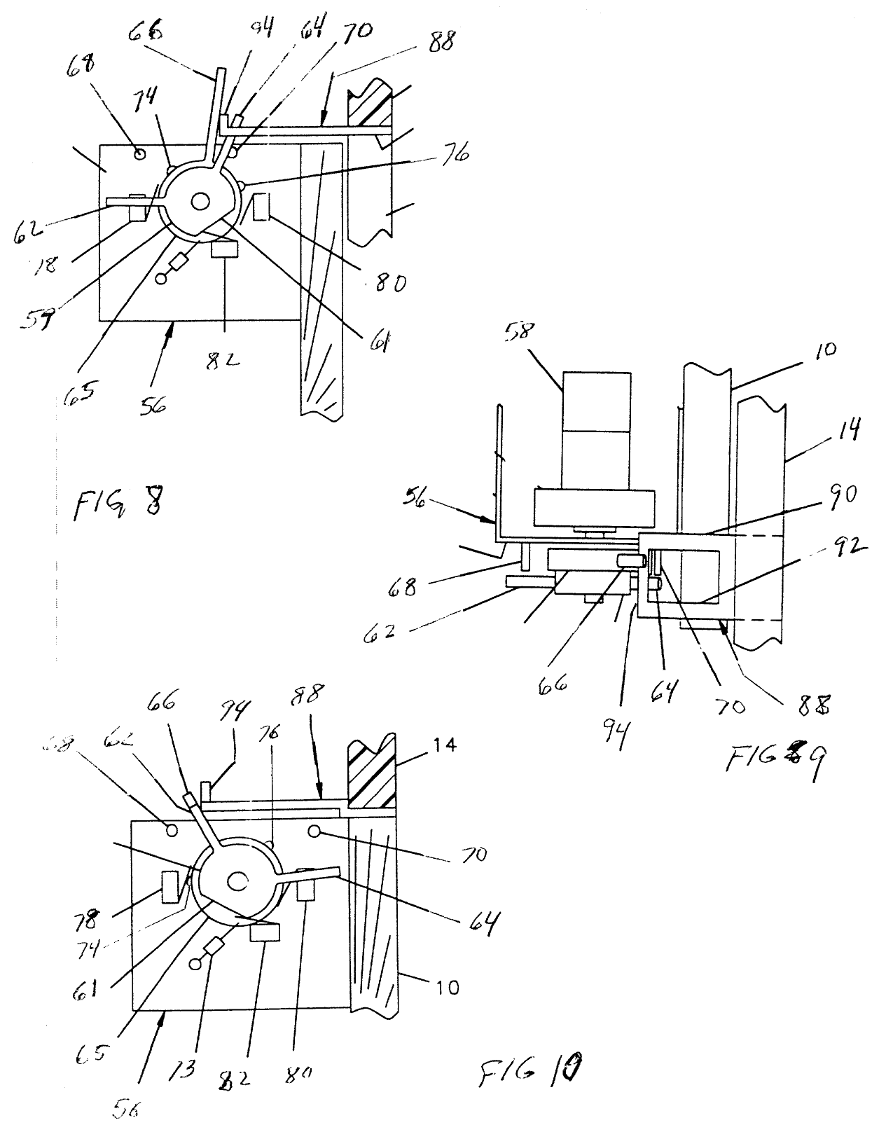

Attached to the wall 14 is a second bracket 88 having parallel arms 90, 92 and an outer cross member 94. When the door 10 is in an open position the detector arm 66 of the engagement unit 56 is spaced from the second bracket 88 as shown in FIG. 7. When the door 10 is moved to an ajar position as shown in FIG. 8, the detector arm 66 will contact the cross member 94 and cause it to rotate into a more vertical orientation as depicted. The rotation of the detector arm 66 will cause the protrusion 76 on cam 59 to be rotated away from the first switch 80, thereby providing a signal that the door has moved to the ajar position. In response to this signal the device 18 will then move the door 10 from the ajar position shown in FIG. 8 to a closed position shown in FIG. 10. Movement of the door 10 is accomplished by the motor rotating the shaft 60 in a counter clockwise direction causing pin 64 to move between the arms 90, 92 and contact the rear surface of the cross member 94. Further counter-clockwise rotation of the shaft 60 will cause the pin 64 to apply force to cross member 94 and force the door 10 into the closed position. When the door reaches the closed position, the detector arm 66 will be moved to the orientation shown in FIG. 10 and the protrusion 74 will engage the second switch 78 thereby providing a signal that the door 10 has reached the closed position. Once the door has reached the closed position the motor 58 is reversed and the cam 59 is rotated in the clockwise direction until the third switch 82 engages the flat 61 of the cam 59, after which power to the motor is terminated.

To move the door from the closed position to the ajar position, the assist 18 works in the reverse sequence. When the door is closed, the detector arm 66 is in the orientation shown in FIG. 10 such that protrusion 74 depresses the second switch 78. When a signal from the infrared transmitter 24 is received by the receiver 26 to initiate an opening sequence, the motor 58 will rotate the shaft 60 in a clockwise direction, causing the drive pin 62 to move from the orientation depicted in FIG. 7, to the orientation depicted in FIG. 10 where it will contact the outer surface of the cross member 94. Further rotation of the shaft 60 will apply force against the cross member 94 and pull the door 10 out of the opening 13. When the door has been pulled sufficiently out of the door frame 13 to reach the ajar position, the detector arm 66 will be rotated to the position shown in FIG. 8, thereby pulling the second protrusion 76 away from the second switch 80. The motor 58 is again reversed until the cam 59 returns to the stand by position.

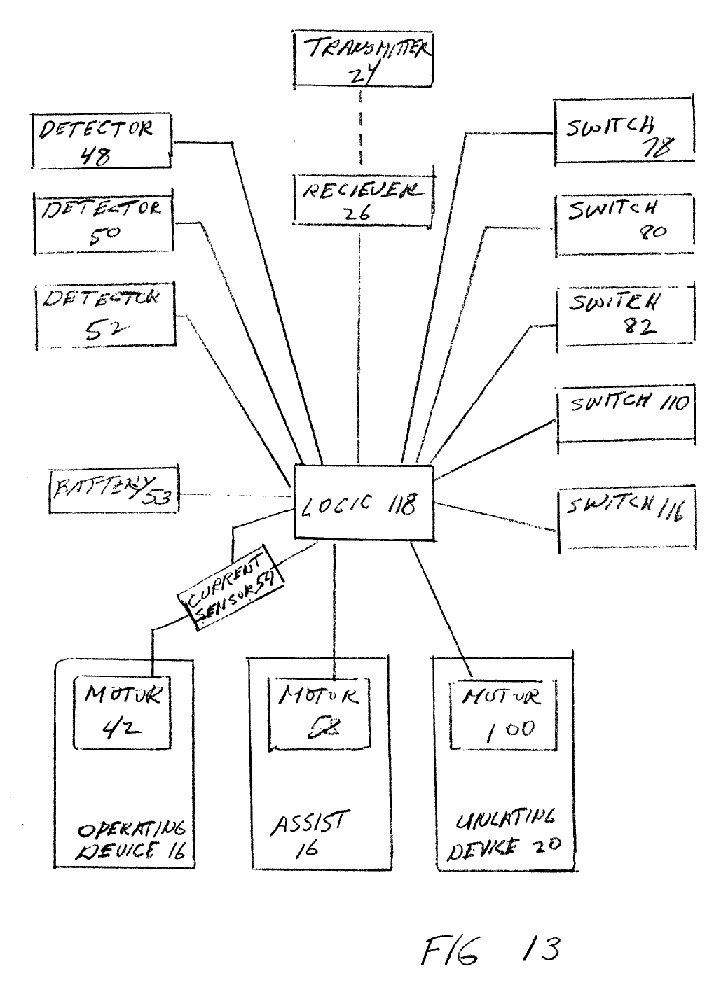

Referring to FIGS. 11 and 12, the invention further includes an unlatching device 20 which includes a housing 96 having mounting holes 98, 99 through which screws are passed for removeably retaining the housing 96 to the surface of the door 10. The unlatching device 20 includes a motor 100 for rotating a spool 102 for winding and unwinding the cable 22 attached to the door handle 11 of the door latch 23.

A first cam 104 and a second cam, not visible but behind cam 104 as shown in FIG. 12, are mounted around a cylindrical portion of the spool 102 so as to be adjustable with respect to the spool 102 but rotate therewith. The first cam 104 has a protrusion 106 thereon and the second cam has a protrusion 108 thereon. Protrusion 106 engages a first limit switch 110 when the spool 102 is rotated a sufficient angular distance (counter-clockwise as shown in FIG. 12) to wind the cable 22 until the lever arm 11 is pulled into a downward orientation as shown in broken lines in FIG. 11, thereby withdrawing the latch pin 112 from a latch plate 114 and unlatching the door 10. The second protrusion 108 of cam 104 engages a second switch 116 after the spool 102 is rotated sufficiently far in the opposite direction (clockwise as shown in FIG. 12) for the cable 22 to unwrap until the spring in the latch 23 returns the arm 11 to the horizontal orientation shown in solid lines in FIG. 11. When in this orientation, the latch pin 112 is extended and can engage the latch plate 114 for retaining the door 10 in the latched orientation.

Referring to FIG. 13, the present invention includes a logic 118 which is preferably in the form of a micro processor. The logic 118 receives input from the detectors 48, 50, 52 from the door operating device 16, from the switches 78, 80, 82 of the assist 18, and the switches 110, 116 of the unlatching device 20. The logic also controls power to the motor 42 of the operating device 16, the motor 58 of the assist 18 and the motor 100 of the unlatching device 20. The logic 118 also receives a signal from the infrared receiver 26, which in turn responds to a start signal from the transmitter 24. When the door is in the closed position and the transmitter 24 signals to initiate an opening sequence, the logic 118 directs power to the motor 100 of the unlatching device to rotate the spool 102 to thereby withdraw the latch pin 110 from the latch plate 114. Once the door has been unlatched, the logic 118 directs power to the motor 58 of the assist 18 to push the door 10 from the closed position to the ajar position. Simultaneously with directing power to the motor 58 of the assist 18, power is directed to the motor 30 of the door operator 16 to urge the arm 34 around the drive shaft 32 to thereby push the door from the closed position to the open position.

The closing cycle operates in substantially the reverse sequence as the opening cycle. Upon receipt of a signal from the transmitter 24 to close an open door, the logic 118 directs power to the motor 30 of the door operator 16 to close the door. When the switch 80 of the assist 18 detects that the door 10 has moved to the ajar position, the motor 58 of the assist is energized to provide additional force to move the door to the closed position. The logic 118 may also be programmed to operate the motor 100 of the unlatching device 20 to reduce resistance to the closing of the door as it enters the door frame 13.

I have found that it is beneficial to program the logic 118 to move the parts of the door operating device 16, the assist 18 and the unlatching device 20 to their respective stand by positions immediately after the device is powered up so as to position the parts so that they will not interfere with the manual operation of the door. Once the system has gone through a cycle to open or close the door, I have found that it is again desirable for the logic 118 to again direct all systems to return to their respective stand by positions.

There are several configurations for the operation of the present invention. For example, the door operator 16 and the assist 18 can be assembled into a single enclosure which fits at the top of the door 10, thereby improving its physical appearance. In this configuration, the operator 16 and the assist 18 act as a single unit. During the opening sequence the motor 58 of the assist 18 is actuated simultaneously with the motor 30 of the door operator 16 to move the door out of the frame 13, after which the cam 61 of the assist 18 is returned to its standby position while the motor 30 of the door operator 16 continues to move the door 10 to the open position. Conversely, during a closing operation the motor 30 is started first and the motor 58 is initiated after the detector switch 80 indicates that the door 10 has reached the ajar position. The motor 58 is then energized to apply additional force to move the door into the closed position.

In another configuration of the invention, the door operator 16 can be combined with the unlatching device 20 and the assist 18 omitted altogether. This combination is suitable for interior doors where very little resistance is encountered in moving the door between the ajar position and the closed position. To open a door 10 fitted with this embodiment, the cycle again begins with a signal from the transmitter 24 which is transmitted to the logic 118. The logic then directs the motor 100 of the unlatching device 20 to rotate the spool 102 and withdraw the latch pin 112. After the pin 112 is withdrawn, the motor 30 of the door operator 16 is energized to move the door 10 to the open position. The motor 100 of the unlatching device is also reversed allowing the handle 11 to return to the horizontal orientation and allow the latch pin 112 to project from the latch. In a closing cycle, the motor 30 of the door operator 16 is energized along with the motor 100 of the unlatching device 20 so that the latch pin 112 is withdrawn by the time the door 10 moves into the door frame 13. The door operator 16 retains the drive pin 46 against the first arm 34 to hold the door 10 in the closed position until the motor 100 of the unlatching device unwinds the spool 102 allowing the latch pin 112 to re-engage the latch plate 114.

In the configuration described above, the motor 30 of the operator 16 can be programmed to continue to apply power to the motor 30 after the door has closed until the current sensor 54 detects an overload condition to thereby exert an additional thrust to push the door deeper into the frame 13 to thereby ensure that the latch pin 112 has engaged the latch plate 114. After applying the additional push, and the current sensor 54 has measured an excessive current to the motor 30, the logic 118 reverses the direction of the motor 30 until it returns to the standby position.

The logic 118 can also be programmed to power the motor 30 of the door operator 16 to perform a “door check” if the door 10 has been manually closed, but the detectors determine that the door 10 is not in a fully closed position. For example, if detector switches 78, 80 determine that the door has moved from the ajar position towards the closed position, but that it has not yet reached the closed position, and a given amount of time has elapsed, perhaps a few minutes, the logic 118 will initiate a closing cycle to force the door into the closed position.

The invention can be used in conjunction with a spring loaded door closing device which will urge an open door into a closed position. Spring loaded door closers are sometimes required by law for certain doors where their presence is needed to retard the advancement of fire or the like. Where used on such doors the logic 118 can be programmed to hold the door open for a fixed period of time, perhaps thirty seconds, to allow the user to maneuver his wheel chair through the door. After the fixed period of time expires, the door operator is programmed to return to the stand by position, thereby allowing the door to be closed by the spring loaded closer. The device could also be programmed to thereafter perform a door check if the sensors indicate that the spring loaded closer failed to completely closed the door.

It will be appreciated that although several embodiments of the invention have been described herein, there are many other variations and combinations of the elements which fall within the true spirit and scope of the invention. It is, therefore, the intent of the appendent claims to cover all such variations and combinations which fall within the true spirit and scope of the invention.

What is claimed:

1. A door operating device for opening a door in a wall, said door moveable between an open position and a closed position and having an ajar position between said open position and said closed position, said door having a rotatable handle for retracting a latch bolt from a latch plate in said wall while said door is in said closed position, said door operating device comprising
a linkage having a first connector attachable to said door, a second connector attachable to said wall, and having a power driven moveable means,
said moveable means moveable in a first direction to move said door from said closed position to said open position,
unlatching means for unlatching said door while said door is in said closed position,
said unlatching means attachable to said door and said rotatable handle and having a motor for rotating said handle and retracting said latch bolt,
a start means for generating a signal to start a door opening sequence, and
control means responsive to said signal from said start means for commencing the operation of said unlatching means and for commencing movement of said moveable means in said first direction wherein said door will be unlatched and moved to said open position.

2. The device of claim 1 wherein
said moveable means is driven by a first motor.
said unlatching means is driven by a second motor, and
said control means directs power to said first motor and said second motor.

3. The combination comprising
a door in an opening in a wall,
said door moveable between an open position and a closed position and having an ajar position between said open position and said closed position,
a door operating device for moving said door between said ajar position and said open position,
an assist for moving said door between said closed position and said ajar position, and
means for coordinating the operations of said door operating device and said assist wherein said assist will move said door from said closed position to said ajar position and said door operating device will move said door from said ajar position to said open position after said door reaches said ajar position.

4. The combination of claim 3 and further comprising
a latch between said door and said wall for releasably latching said door in said closed position,
said latch having a rotatable handle, and
unlatching means for unlatching said door, said unlatching means attached to said door and said rotatable handle and having a motor for rotating said handle for retracting said bolt.

5. The combination of claim 3 wherein said assist comprises moveable means moveable in a first direction for moving said door from said ajar position to said closed position and moveable in a second direction for moving said door from closed position to said ajar position.

6. A kit for attachment between a door and a wall, said door moveable between an open position in which an end of said door is spaced from said wall, an ajar position, and a closed position, said kit for urging said door between said closed position and said open position, said kit comprising
a connector attachable to one of said door and said wall,
moveable means attachable to the other of said door and said wall, said moveable means driven by a first motor,
said moveable means for applying force to said door for moving said door from said ajar position to said closed position and for applying force to said door for moving said door closed position to said ajar position,
said moveable means spaced from said connector when said door is in said open position and engaged with said connector when said door is in said ajar position and said closed position,
a door operator having a linkage attachable between said door and said wall, said door operator for moving said door from said ajar position to said open position,
said door operator driven by a second motor, and
means for controlling said first motor and said second motor for providing unified movement of said door between said closed position and said open position.

7. The kit of claim 6 wherein said door has a door latch with a retractable latch bolt for engaging a latch plate on said wall, said bolt retractable by rotating a handle, said kit further comprising
an unlatching device attachable to said door and said handle, said unlatching device to rotating said handle and retracting said bolt,
said unlatching device having a third motor, and
said means for controlling also controlling said third motor for unlatching said door before moving said door from said closed position to said open position.

8. The method of controlling the opening of a door in a wall, said door moveable between an open position, and a closed position, and having an ajar position between said open and said closed position, said door having a latch with a retractable bolt for engaging a latch plate on said wall, said bolt retracted by rotating a handle on said latch, said method comprising the steps of,
providing a door operating device attachable to said door and said wall, said door operating device for moving said door from said closed position to said open position,
attaching said door operating device to said door and said wall,
providing an unlatching device attachable to said door and said handle for rotating said handle to unlatch said door,
attaching said unlatching device to said door and said handle,
providing means for coordinating the operators of said unlatching device and said door operating device wherein said unlatching device will unlatch a closed door after which said door operating device will open said door.

9. The method of claim 8 wherein said door operating device also moves said door from said open position to said closed position and said means for coordinating the operations of said unlatching device and said door operating device will carry out the steps of
said unlatching device rotating said handle to retract said latch bolt while said door is in said open position,
said door operating device moving said door from said open position to said closed position,
said unlatching device releasing said handle to extend said bolt into said latch plate,
said door operating device holding said door in said closed position until said unlatching device has released said handle to extend said bolt, and
terminating power to said door operating device after said unlatching device has released said handle to extend said bolt.

10. The method of claim 8 and comprising the further steps of
providing an assist attachable to said door and said wall, said assist for applying additional force to move said door between said closed position and said ajar position,
attaching said assist to said door and said wall, and
providing said means for coordinating where said means for coordinating coordinates the operations of said unlatching device, said door operating and said assist wherein said unlatching device will unlatch a closed door after which said assist will urge said door from said closed position to said ajar position and said door operating device will open said door.
